(19) United States
(12) Patent Application Publication
(10) Pub. No.: US 2009/0160185 A1
(43) Pub. Date: Jun. 25, 2009

(54) QUICK CONNECT FITTING

(76) Inventors: Robert Learmont, Howell, MI (US); William Turnau, Canton, MI (US)

Correspondence Address: Masco Corporation, 21001 Van Born Road, Taylor, MI, 48480, US

(21) Appl. No.: 11/959,807

(22) Filed: Dec. 19, 2007

(51) Int. Cl. F16L 41/00; F16L 3/00; F16L 37/00; F16K 15/00

(52) U.S. Cl. 285/305; 285/133.11; 285/61; 137/455

(57) ABSTRACT

An example quick connect fitting assembly includes a fitting for communicating flow between at least three openings. A quick connect portion of the fitting defines one of the openings. The quick connect portion is for connecting the fitting to a conduit

### BACKGROUND OF THE INVENTION

This invention relates to a quick connect fitting for dividing the flow from a stub-out.

Current practice during building construction is to complete the rough-in plumbing and provide a stub-out pipe so that the rough-in plumbing may be checked for leaks, etc. The stub-out pipe is generally a small diameter pipe. After capping the stub-out pipe and checking for leaks, plumbers connect a plumbing fixture, such as a dishwasher or a faucet, to the stub-out pipe. Often, it is desirable to connect more than one fixture near the location of a single stub-out and to divide the flow from a single stub-out.

Stub-outs are frequently located under kitchen cabinets and other cramped areas. The stub-outs are sometimes difficult to connect to fixtures, especially if using adhesive or fusion bonding between the stub-out and the plumbing from the stub-out to the fixture. Further, these traditional plumbing means are often time consuming, require several additional tools, and are difficult to verify.

### SUMMARY

An example quick connect fitting assembly includes a fitting for communicating flow between at least three openings. A quick connect portion of the fitting defines one of the openings. The quick connect portion is for connecting the fitting to a conduit.

The example quick connect fitting assembly may include a fitting for communicating flow from a stub-out conduit between at least three openings within the fitting. A quick connect includes a mount housing having a multitude of fingers defined about an axis and a slot generally transverse to the axis. The quick connect further includes a retainer mountable within the slot. The retainer has a set of conduit attachment legs and a set of housing attachment legs defined within a common plane. The set of housing attachment legs engages a surface within the slot to retain the stub-out conduit within the mount housing.

The example quick connect fitting may include a quick connect assembly having a mount housing and a retainer. The mount housing has a multitude of circumferential fingers defined about an axis and a slot generally transverse the axis. The retainer mounts at least partially within the slot. The retainer has a set of conduit attachment legs and a set of housing attachment legs defined within a common plane. The set of housing attachment legs engages a corresponding surface within the slot to retain the retainer within the mount housing. The quick connect assembly is securable to a conduit adjacent an opening within the conduit. The conduit is for communicating flow between at least three conduit openings.

### BRIEF DESCRIPTION OF THE DRAWINGS

These and other features of the present invention can be best understood from the following specification and drawings, the following of which is a brief description:

FIG. 1 is a general perspective view of an example quick connect fitting assembly;

FIG. 2 is another perspective view of the FIG. 1 quick connect fitting assembly engaging two stops and a stub-out conduit;

FIG. 3 is an exploded view of the FIG. 1 quick connect fitting assembly;

FIG. 4 is a side view of the FIG. 1 quick connect fitting assembly;

FIG. 5A is a sectional view of the FIG. 1 quick connect fitting assembly taken along the length thereof in an unlocked position;

FIG. 5B is a sectional view of the FIG. 1 quick connect fitting assembly taken along the length thereof in a locked position; and

FIG. 6 is a sectional view taken at line 3D-3D in FIG. 4.

### DETAILED DESCRIPTION OF THE PREFERRED EMBODIMENT

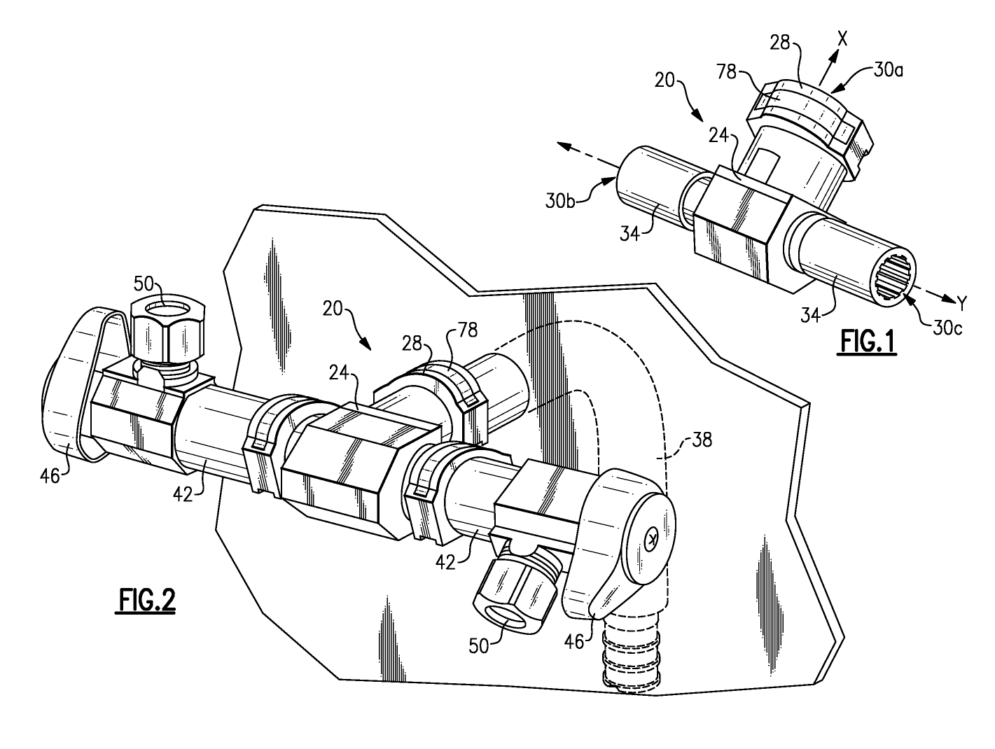

FIG. 1 shows an example quick connect fitting assembly 20 having a fitting portion 24 and a quick connect portion 28. In this example, the fitting assembly 20 moves flow between three openings 30a, 30b, 30c. The quick connect portion 28 defines the opening 30a, and the fitting assembly 20 includes two extensions 34 each defining one of the other openings 30b, 30c.

Referring now to FIG. 2 with continuing reference to FIG. 1, the quick connect portion 28 of the fitting assembly 20 engages a stub-out conduit 38. Flow of water, for example, moves through the stub-out conduit 38 in a known manner. The fitting portion 24 divides flow from the stub-out conduit 38 directing some of the flow through the opening 30b and some of the flow through the opening 30c. In this example, stops 42 engage each of the extensions 34. The stops 42 each include a valve 46 for controlling flow from the stop openings 50. Turning the valves 46 controls flow through the stop openings 50 in a known manner. Although the fitting assembly 20 is generally described as controlling flow moving from the stub-out conduit 38, other examples may include controlling flow moving from the fitting assembly 20.

In this example, a Y axis defined by the extensions 34 is perpendicular to the axis X defined by the quick connect portion 28 and the opening 30a associated with the quick connect portion 28. Accordingly, the example fitting assembly 20 has a general T profile. As the openings 30a, 30b, 30c are defined either by the quick connect portion 28 or the extension 34 for receipt within a quick connect portion of another plumbing device, the fitting assembly 20 divides flow between the openings 30a, 30b, 30c without threaded fasteners or adhesives.

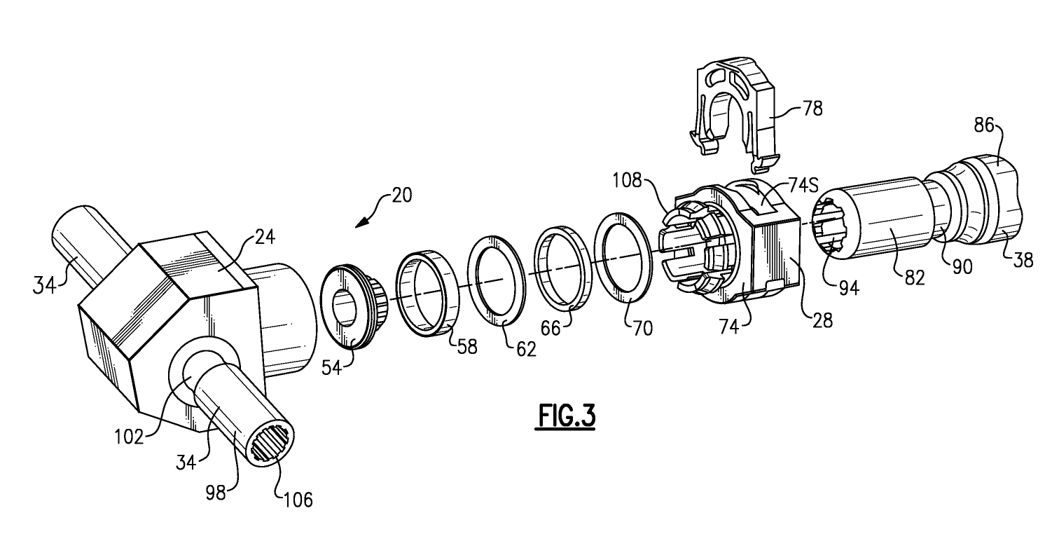

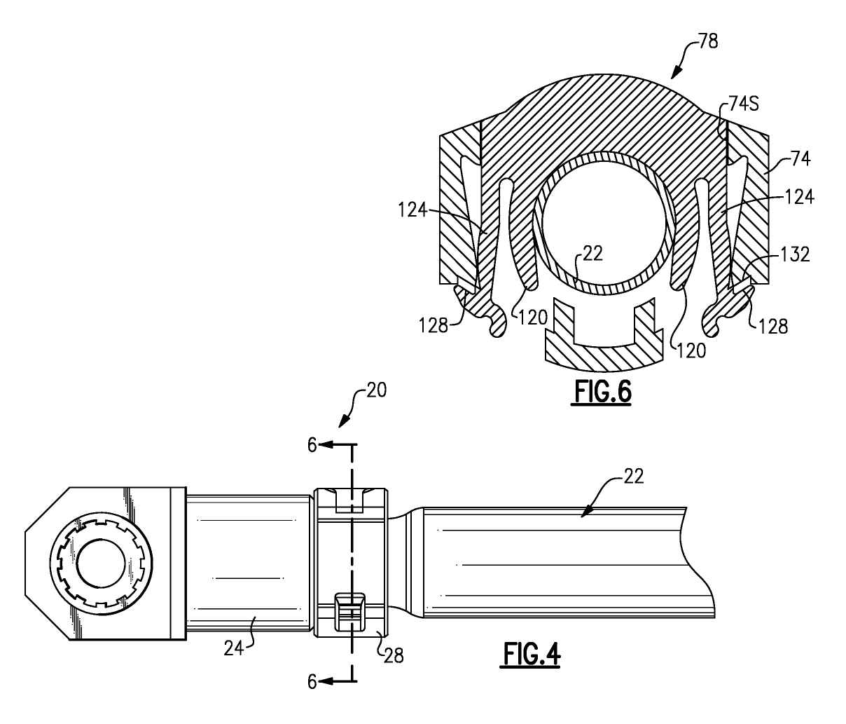

Referring now to FIGS. 3 and 4, the quick connect portion 28 of the quick connect fitting assembly 20 generally includes an anti-rotation disc 54, an anti-rotation spacer 58, a first o-ring seal 62, a spacer 66, a second o-ring seal 70, a mount housing 74, and a retainer 78, which fits within a mount housing slot 74s. In this example, the quick connect portion 28 is attachable to the stub-out conduit 38 without adhesive or welding.

The stub-out conduit 38 generally defines a smaller diameter 82 and a larger diameter 86, which together adapt the stub-out conduit 38 for receipt within the quick connect portion 28. The smaller diameter 82 defines an attachment groove 90 for receipt of the retainer 78. An internal structure 94, such as a multitude of splines, are engageable with the anti-rotation disc 54 to rotationally fix the fitting assembly 20 on the stub-out conduit 38.

The extensions 34 include structures similar to the stub-out conduit 38. That is, the extensions 34 each include a diameter 98 defining a groove 102 and an internal structure 104. Such geometry facilitates receipt and retention of the extensions 34 within the quick connect portion of another plumbing device, such as the stops 42 of FIG. 2. In this example, the fitting assembly 20 provides two extensions 34 suitable for engagement by other quick connect plumbing devices. As known, the stub-out conduit 38 is engageable by only the one quick connect portion 28.

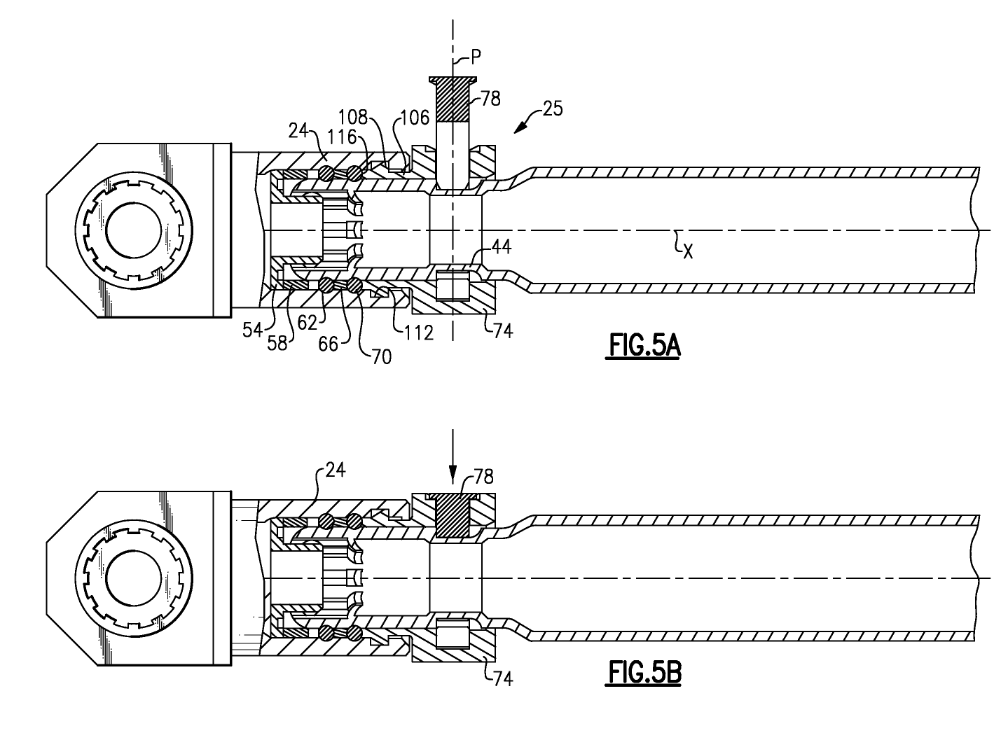

Referring to FIGS. 5A and 5B, the mount housing 74 includes a multitude of circumferential fingers 106 defined about a longitudinal axis X. Each finger 106 includes a barbed end 108 (FIG. 3). The barbed end 108 engages a corresponding internal groove 112 within the fitting portion 24. The barbed end 108 further defines a stop surface 116, which axially retains the o-ring seal 70, the spacer 66, and the o-ring seal 62 within the fitting portion 24. The mount housing 74 fits over the smaller diameter 82 and the retainer 78 aligns with the attachment groove 90.

As shown in FIG. 6, the retainer 78 includes a partially annular set of conduit attachment legs 120 and a set of housing attachment legs 124. The conduit attaching legs 120 and the housing attachment legs 124 are defined within a common plane P (FIG. 5). The conduit attachment legs 120 engage the attachment groove 90 to axially retain the stub-out conduit 38 therein. The housing attachment legs 124 each include a barbed end 128, which engage a corresponding surface 132 located within the slot 74s.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A quick connect fitting assembly, comprising:
a fitting for communicating flow between at least three openings; and
a quick connect portion of said fitting defining one of said at least three openings, said quick connect portion for connecting said fitting to a conduit.

2. The quick connect fitting assembly of claim 1, wherein said quick connect portion extends from said fitting transverse to an axis defined by another of said at least three openings.

3. The quick connect fitting assembly of claim 1, including a first extension defining another one of said at least three openings, said first extension for receipt within a quick connect mount housing.

4. The quick connect fitting assembly of claim 3, including a second extension defining another one of said at least three openings, said second extension for receipt within another quick connect mount housing.

5. The quick connect fitting assembly of claim 3, wherein said first extension extends from said housing in a first direction and said quick connect portion extends from said fitting in a second direction transverse to said first direction.

6. The quick connect fitting assembly of claim 4, wherein said quick connect portion defines an axis transverse to an axis defined by said first extension and said second extension.

7. The quick connect fitting assembly of claim 1, wherein said fitting is T-shaped.

8. The quick connect fitting assembly of claim 1, wherein said quick connect portion includes a mount housing for receiving a stub-out conduit.

9. The quick connect fitting assembly of claim 1, wherein said quick connect portion includes a retainer having a set of conduit attachment legs and a set of housing attachment legs defined within a common plane, said set of housing attachment legs engageable with a corresponding surface within a slot defined by said quick connect portion to retain the conduit.

10. The quick connect fitting assembly of claim 1, wherein said fitting does not include a threaded portion.

11. A fitting assembly, comprising:
a fitting for communicating flow between a stub-out conduit and at least three openings; and
a quick connect including a mount housing having a multitude of circumferential fingers defined about an axis and a slot generally transverse to said axis,
said quick connect further including a retainer mountable at least partially within said slot, said retainer having a set of conduit attachment legs and a set of housing attachment legs defined within a common plane, said set of housing attachment legs engageable with a corresponding surface within said slot to retain the stub-out conduit within said mount housing.

12. The fitting assembly of claim 11, wherein the fitting is a T-shaped fitting.

13. The fitting assembly of claim 11, wherein said mount housing at least partially defines one of said at least three openings.

14. The fitting assembly of claim 13, wherein the opening at least partially defined by said mount housing is transverse another of said at least three openings.

15. The fitting assembly of claim 11, including a first extension defining another one of said at least three openings and having a first extension attachment groove, said first extension retainable within a mount housing of another quick connect.

16. The fitting assembly of claim 15, including a second extension defining another one of said at least three openings and having a second extension attachment groove, said second extension retainable within a mount housing of another quick connect.

17. The fitting assembly of claim 1, wherein said fitting does not include a threaded portion.

18. A method of controlling flow, comprising:
moving flow between a stub-out conduit and T-shaped fitting that includes a quick connect portion for engaging the stub-out conduit; and
dividing flow with the T-shaped quick connect fitting.

19. The method of claim 18, controlling flow from the T-shaped quick connect fitting using at least one stop.

20. The method of claim 19, wherein the at least one stop includes a quick connect portion for engaging the quick connect fitting.
